(19) United States
(12) Patent Application Publication
(10) Pub. No.: US 2024/0192497 A1
(43) Pub. Date: Jun. 13, 2024

(54) VIRTUAL IMAGE DISPLAY DEVICE AND HEAD-MOUNTED DISPLAY APPARATUS

(71) Applicant: SEIKO EPSON CORPORATION, Tokyo (JP)

(72) Inventor: Mitsutaka IDE, SHIOJIRI-SHI (JP)

(73) Assignee: SEIKO EPSON CORPORATION, Tokyo (JP)

(21) Appl. No.: 18/530,224

(22) Filed: Dec. 6, 2023

(30) Foreign Application Priority Data
Dec. 8, 2022 (JP) 2022-196175

(51) Int. Cl. G02B 27/01

(52) U.S. Cl. CPC G02B 27/0172; G02B 2027/0178

(57) ABSTRACT

A virtual image display device includes an image display device including a pixel display region for displaying an image and a light transmitting region for causing an external to be visually recognizable, a light shielding member being arranged on an external side of the image display device and being configured to suppress incidence of external light on the pixel display region, a polarizing plate being arranged on a face side of the image display device and being configured to limit transmitted light to a predetermined polarization direction, an image selection conversion member being arranged on a face side of the polarizing plate and including a wavelength plate for selectively changing a polarization direction of image light according to the pixel display region, and a polarization separation lens element being arranged on a face side of the image selection conversion member.

The present application is based on, and claims priority from JP Application Serial Number 2022-196175, filed Dec. 8, 2022, the disclosure of which is hereby incorporated by reference herein in its entirety.

### BACKGROUND

### 1. Technical Field

The present disclosure relates to a virtual image display device and a head-mounted display apparatus that enable observation of a virtual image, and more particularly to a virtual image display device and the like of a see-through type that enable visual recognition of an external image.

### 2. Related Art

There has been publicly known a virtual image display device including a display, a beam splitter that transmits light from the display, a concave mirror that reflects the light transmitted through the beam splitter to a wearer via the beam splitter, and an adjustable lens that is arranged between the beam splitter and the concave mirror and changes a focal point of an image (JP-T-2019-507367).

When an angle of view is increased in the device described above, the beam splitter is increased in thickness. Thus, the optical system as a whole is disadvantageously increased in size.

### SUMMARY

According to one aspect of the present disclosure, a virtual image display device includes an image display device including a pixel display region for displaying an image and a light transmitting region for causing externals to be visually recognizable, a light shielding member being arranged on an external side of the image display device and being configured to suppress incidence of external light on the pixel display region, a polarizing plate being arranged on a face side of the image display device and being configured to limit transmitted light to a predetermined polarization direction, an image selection conversion member being arranged on a face side of the polarizing plate and including a wavelength plate for selectively changing a polarization direction of image light according to the pixel display region, and a polarization separation lens element being arranged on a face side of the image selection conversion member and having refractive power selectively acting on polarization of the image light.

### BRIEF DESCRIPTION OF THE DRAWINGS

FIG. 1 is an external perspective view for describing a mounted state of a virtual image display device according of a first exemplary embodiment.

FIG. 2 is a schematic perspective view for describing an optical structure of a display optical system.

FIG. 3 is an enlarged perspective view for describing a repetition unit of a composite display member.

FIG. 4A is a schematic perspective view for describing one example of a specific configuration of a light emitting element.

FIG. 4B is a schematic perspective view for describing another example of the light emitting element.

FIG. 5A is a plan view for describing arrangement of pixels and an interval in association with FIG. 4A.

FIG. 5B is a plan view for describing arrangement of pixels and an interval in association with FIG. 4B.

FIG. 6 is a view illustrating the case illustrated in FIG. 5A while overlapping a light shielding layer of a light shielding member therewith.

FIG. 7 illustrates a light shielding layer when a cell region of each color is formed separately.

FIG. 8 is a schematic perspective view for describing a structure and a function of a liquid crystal lens.

FIG. 9 is a schematic view for describing an operation of the virtual image display device of the first exemplary embodiment.

FIG. 10 is a view for describing a display optical system in a modification example.

FIG. 11 is a view for describing a display optical system in a modification example.

FIG. 12 is a schematic view for describing a virtual image display device of a second exemplary embodiment.

FIG. 13 is a view for describing a display optical system in a modification example.

### DESCRIPTION OF EMBODIMENTS

### First Exemplary Embodiment

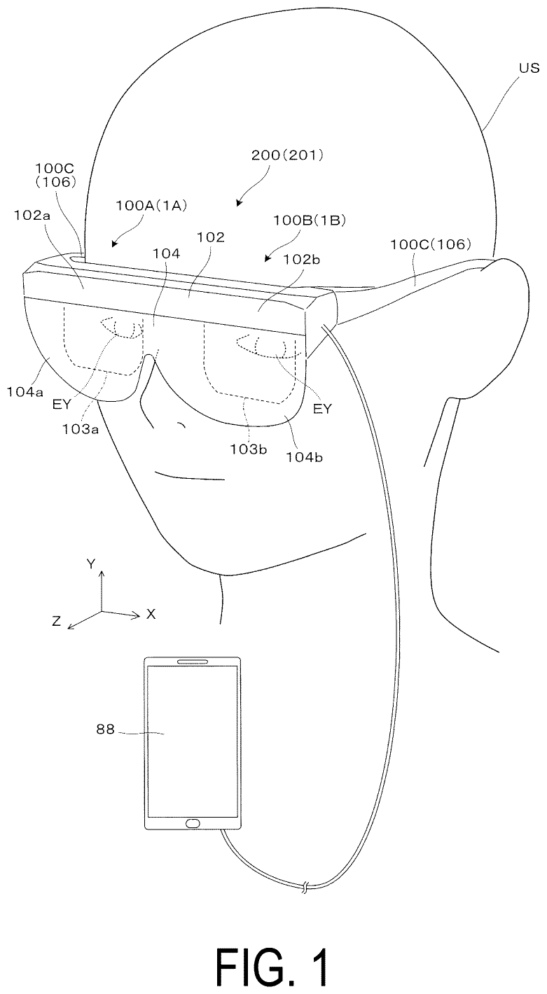

With reference to FIGS. 1 to 9, a virtual image display device according to a first exemplary embodiment of the present disclosure is described below.

FIG. 1 is a perspective view for describing a mounted state of a head-mounted display, in other words, a head-mounted display apparatus 200. The head-mounted display apparatus (hereinafter, also referred to as an HMD) 200 is a display apparatus 201 of a binocular type, and allows an observer or a wearer US who wears the HMD 200 to recognize a video as a virtual image. In FIG. 1 and the like, X, Y, and Z indicate an orthogonal coordinate system, a +X direction corresponds to a lateral direction in which both eyes EY of the observer or wearer US wearing the HMD 200 are aligned, a +Y direction corresponds to an upward direction orthogonal to the lateral direction in which both the eyes EY are aligned for the wearer US, and a +Z direction corresponds to a forward or front direction for the wearer US. The +Y directions are parallel to the vertical axis or the vertical direction.

The HMD 200 includes a first virtual image display device 100A for a right eye, a second virtual image display device 100B for a left eye, a pair of temples 100C that support the virtual image display devices 100A and 100B, and a user terminal 88 being an information terminal. The first virtual image display device 100A is a first device 1A, and is constituted by a first display driving unit 102a that is arranged in an upper part, a first display optical system 103a that covers the front of the eyes, and a light transmitting cover 104a that covers the first display optical system 103a from the external side or the front side thereof. The second virtual image display device 100B is a second device 1B, and is constituted by a second display driving unit 102b that is arranged in an upper part, a second display optical system 103b that covers the front of the eyes, and a light transmitting cover 104b that covers the second display optical system 103b from the external side or the front side thereof. The HMD 200 obtained by combining the first virtual image display device 100A being the first device 1A and the second virtual image display device 100B being the second device 1B with each other is also a virtual image display device in a broader sense. The pair of temples 100C function as a mounting member or a support device 106 that is worn on the head of the wearer US, and support the upper end sides of the pair of display optical systems 103a and 103b and the upper end sides of the pair of light transmitting covers 104a and 104b via the display driving units 102a and 102b integrated in exterior. A combination of the pair of display driving units 102a and 102b is referred to as a driving device 102. A combination of the pair of light transmitting covers 104a and 104b is referred to as a shade 104.

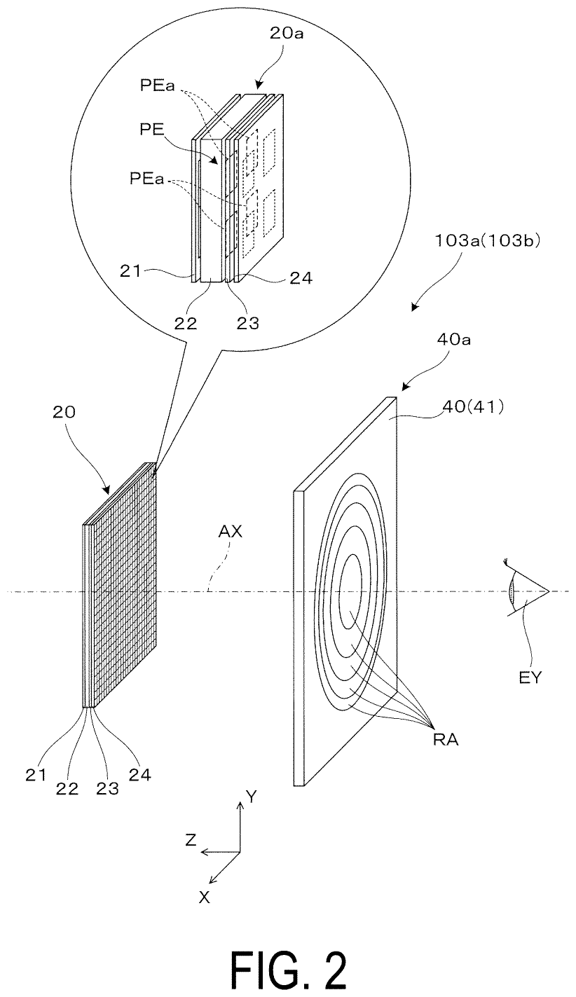

FIG. 2 is a perspective view for describing a structure of the first display optical system 103a. The first display optical system 103a includes a plate-like composite display member 20 that forms a two-dimensional image and emits image light and a polarization separation liquid crystal lens 40 being a polarization separation lens element 40a that functions as a lens with respect to the image light. The composite display member 20 and the polarization separation liquid crystal lens 40 are arranged separate from each other in a direction of an optical axis AX. The composite display member 20 is a plate-like member that extends parallel to an XY plane vertical to the optical axis AX, and has a structure in which a light shielding member 21, an image display device 22, a polarizing plate 23, and an image selection conversion member 24 are laminated and integrated with each other by a frame body, which is omitted in illustration. The composite display member 20 is configured by a plurality of repetition units 20a that are arrayed in a matrix along the XY plane. The repetition unit 20a includes pixels PE each of which is a unit for forming an image in the image display device 22. Each of the pixels PE is configured by four sub pixels PEa. The polarization separation liquid crystal lens 40, that is, the polarization separation lens element 40a is arranged on the face side, that is, the −Z side of the image selection conversion member 24 of the composite display member 20 to cover the front of the eyes. The polarization separation liquid crystal lens 40 is an independent lens that collectively causes the plurality of pixels PE constituting the image display device 22 to form an image. The polarization separation liquid crystal lens 40 is a plate-like member that extends parallel to the XY plane. The polarization separation liquid crystal lens 40 is a liquid crystal lens 41, and includes a plurality of orbicular zones RA each having a circular shape and a different refractive index state. The orbicular zones RA in a group are concentrically arranged symmetrically about the optical axis AX. In the group of the orbicular zones RA, the orbicular zone RA in the periphery away from the optical axis AX has a width in the radial direction with the optical axis Ax as a center, which is smaller than that of the orbicular zone RA at the center through which the optical axis AX passes. In other words, the width of the orbicular zone RA in the radial direction is smaller as approaching the periphery.

The second display optical system 103b is optically similar to the first display optical system 103a, or is obtained by inverting the first display optical system 103a horizontally. Thus, detail description thereof is omitted.

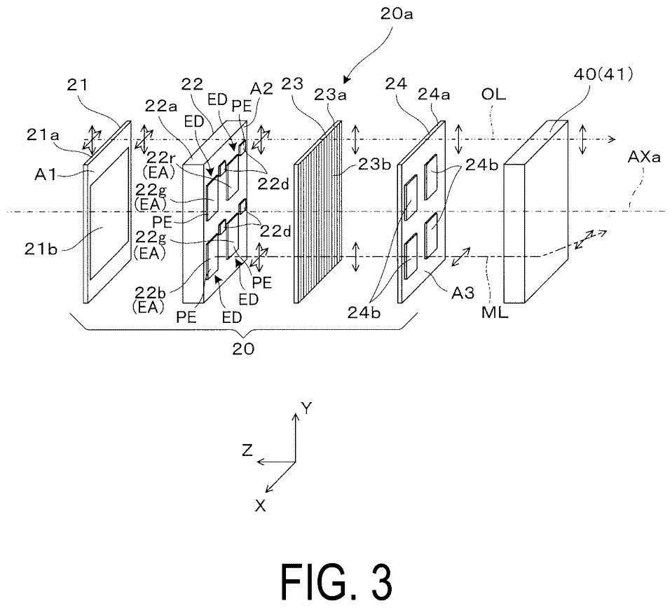

FIG. 3 is an enlarged perspective view for describing the repetition unit 20a of the composite display member 20. Here, an axis AXa is an axis parallel to the optical axis AX illustrated in FIG. 1.

The light shielding member 21 is obtained by providing a rectangular light shielding layer 21b on a flat plate 21a having light transmittance. Although omitted in illustration, on the entire light shielding member 21, the large number of light shielding layers 21b are arrayed in a matrix along the XY plane. In other words, all the light shielding layers 21b constituting the light shielding member 21 are two-dimensionally arrayed periodically with respect to the horizontal X direction and the vertical Y direction. Each of the light shielding members 21b is formed in a region corresponding to a pixel section in each of the repetition units 20a. A light transmitting region A1 of the light shielding member 21 in which the light shielding layer 21b is not provided transmits external light OL, and the light shielding layer 21b suppresses passage of the external light OL.

The light shielding layer 21b is formed by light-absorbing paint or other substances that can be applied to a desired area by an ink-jet method, for example. A mold release pattern formed of a mold release agent is recorded in advance at a position on the flat plate 21a at which the light shielding layer 21b is not formed. A spray containing light-absorbing substances is applied over the entire surface, and then the light-absorbing substances are removed at the position corresponding to the mold release pattern. With this, the light shielding layer 21b may be formed of the remaining light-absorbing substance layer. Paint having a color other than black may be used for the light shielding layer 21b as long as substances contained therein has a light-absorbing action. Moreover, a metal pattern is formed by using a photo-resist technique or the like at a position on the flat plate 21a at which the light shielding layer 21b is to be formed, and the metal pattern is oxidized to improve an absorbing property. The light shielding layer 21b may be thus formed. Note that the light shielding layer 21b is not limited to one formed on the face side of the flat plate 21a and may be formed on the external side of the flat plate 21a.

The image display device 22 is arranged on the face side of the light shielding member 21. The image display device 22 is a transparent display of a light emitting type, for example, an organic EL display. The image display device 22 is obtained by providing light emitting layers 22r, 22g, and 22b being light emitting regions EA and driving elements 22d for lighting up the light emitting layers 22r, 22g, and 22b on a flat plate 22a having light transmittance. Each of a combination of the light emitting layer 22r and the driving element 22d on an upper right side thereof, a combination of the light emitting layer 22g and the driving element 22d on an upper right side thereof, and a combination of the light emitting layer 22b and the driving element 22d on an upper right side thereof is referred to as the light emitting element ED. The light emitting layer 22r for a red color emits red image light at timing and a luminance degree required for display, based on a driving signal from the driving element 22d. The pair of light emitting layers 22g for a green color emit green image light at timing and a luminance degree required for display, based on a driving signal from the driving element 22d. The light emitting layer 22b for a blue color emits blue image light at timing and a luminance degree required for display, based on a driving signal from the driving element 22d. Although omitted in illustration, on the entire image display device 22, the large number of pixels PE in which the four light emitting layers 22r, 22g, and 22b form a group are arrayed in a matrix along the XY plane. In other words, all the pixels PE or all the groups of the light emitting layers 22r, 22g, and 22b that constitute the image display device 22 are two-dimensionally arrayed periodically with respect to the horizontal X direction and the vertical Y direction. Each of the pixels PE, in other words, one group of the light emitting layers 22r, 22g, and 22b and the driving elements 22d associated therewith are formed in a region corresponding to a pixel section in each of the repetition units 20a. In the image display device 22, the light emitting layers 22r, 22g, and 22b and a light transmitting region A2 in which the driving element 22d is not provided transmit the external light OL. The driving element 22d blocks the external light OL, and the light emitting layers 22r, 22g, and 22b block the external light OL at least at timing of lighting.

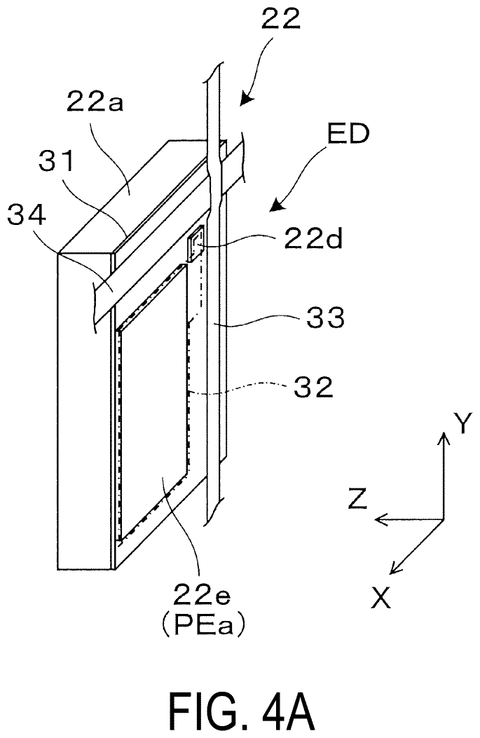

FIG. 4A is a schematic perspective view for describing one example of a specific structure of the light emitting element ED. The light emitting element ED illustrated herein is a display cell of an active matrix type. The flat plate 22a being a base plate for supporting the light emitting element ED is formed of glass or plastic having light transmittance. On the flat plate 22a, a first transparent electrode 31 being a common electrode is uniformly formed. A light emitting layer 22e corresponding to the sub pixel PEa and the driving element 22d being a switch element are formed at a display position on the first transparent electrode 31. The light emitting layer 22e is any one of the light emitting layers 22r, 22g, and 22b that are illustrated in FIG. 3. The light emitting element ED is an organic EL light emitting element, for example. In this case, the light emitting layer 22e is an organic substance layer containing fluorescent substances or the like, and contain an injection layer for an electron or a hole (not illustrated) or the like as required. An output of the driving element 22d is supplied to a second transparent electrode 32 that is provided to cover the light emitting layer 22e. A power supply wiring line 33 that extends in the vertical Y direction and has light transmittance and a switch wiring line 34 that extends in the horizontal X direction and has light transmittance are connected to a terminal of the driving element 22d (not illustrated). The light emitting layer 22e can selectively be caused to emit light by supplying a driving signal from the outside to the switch wiring line 34.

FIG. 4B is a schematic perspective view for describing another example of the light emitting element ED. The light emitting element ED illustrated herein is a display cell of a passive matrix type. The flat plate 22a being a base plate for supporting the light emitting element ED is formed of glass or plastic having light transmittance. On the flat plate 22a, a first electrode wiring line 35 that extends in the horizontal X direction and has light transmittance is formed. The light emitting layer 22e corresponding to the sub pixel PEa is formed at a display position on the first electrode wiring line 35. The light emitting layer 22e is any one of the light emitting layers 22r, 22g, and 22b that are illustrated in FIG. 3. The light emitting element ED is an organic EL light emitting element, for example. A second electrode wiring line 36 that extends the vertical Y direction and has light transmittance is formed to cover the light emitting layer 22e. The light emitting layer 22e can selectively be caused to emit light by supplying power required for the first electrode wiring line 35 and the second electrode wiring line 36 from the outside.

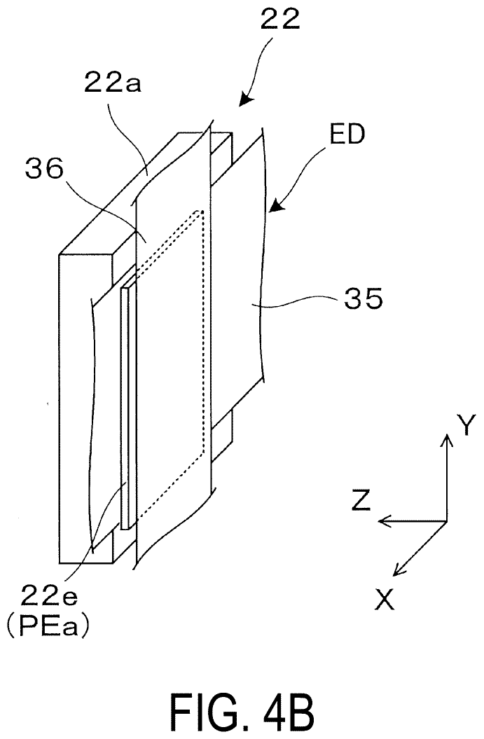

FIG. 5A is a plan view for describing arrangement of the pixels and an interval in the periphery thereof on the image display device 22. On the image display device 22, repetition sections 22s each having a rectangular outline are arrayed in the X direction and the Y direction. Each of the repetition sections 22s includes a pixel section 22t at the center, and a light transmitting region 22u having a frame-like shape or the light transmitting region A2 is formed in the periphery of the pixel section 22t. The pixel section 22t is a pixel display region PA for displaying an image. The pixel section 22t includes four cell regions 22m arranged in 2×2. Each of the cell regions 22m includes the light emitting element ED having the structure illustrated in FIG. 4A. In the pixel section 22t as a whole, the cell regions 22m include the light emitting layers 22r, 22g, and 22b in the Bayer array. The periphery of the light emitting layers 22r, 22g, and 22b is a rectangular frame-like circuit region 22q that is provided with the driving element 22d, the power supply wiring line 33, the switch wiring line 34, and the like, which are illustrated in FIG. 4A.

FIG. 5B is a plan view for describing arrangement of pixels and an interval in the periphery in a case of the light emitting element ED illustrated in FIG. 4B. In this case, the light emitting element ED does not include a driving element or a switch element, and hence only the light emitting layers 22r, 22g, and 22b are formed in the cell region 22m.

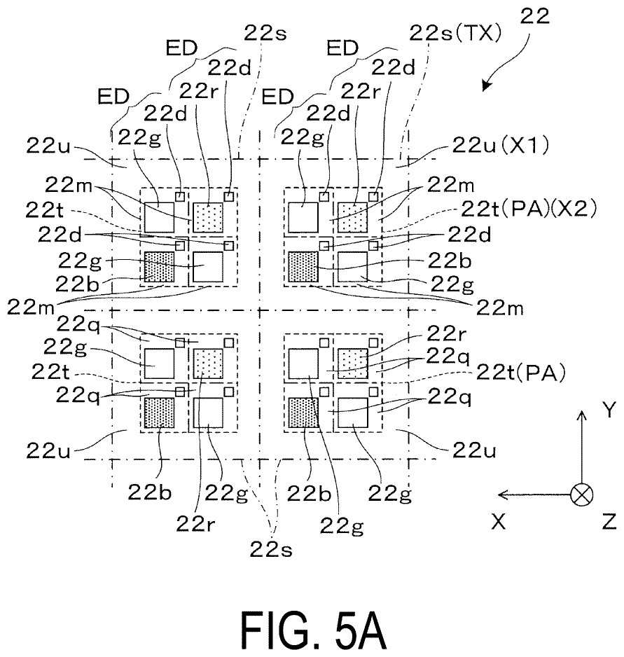

FIG. 6 is a view illustrating the image display device 22 illustrated in FIG. 5A while overlapping the light shielding layer 21b of the light shielding member 21 illustrated in FIG. 3 therewith in a see-through manner. In this case, the light shielding layer 21b covers the pixel section 22t and is formed in a region that spreads slightly outward from the pixel section 22t, but may be formed in a region matching with the pixel section 22t.

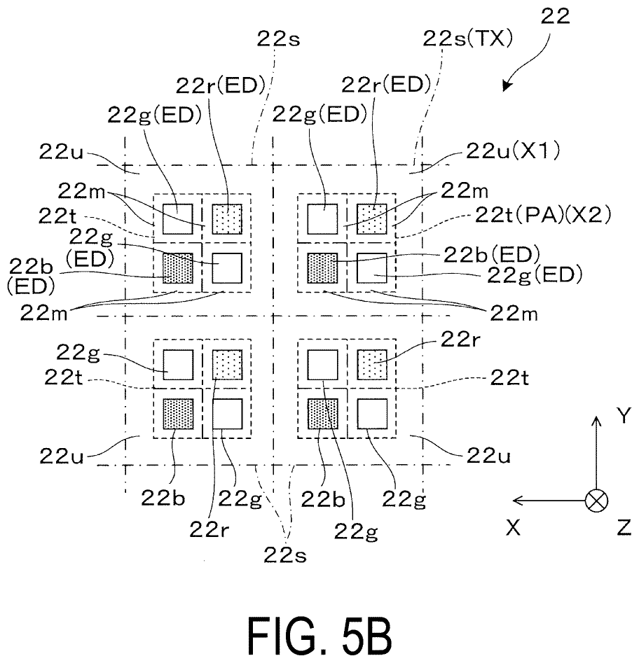

FIG. 7 illustrates a case in which the cell regions 22m of the respective colors are formed separately in the image display device 22. In this case, each of the cell regions 22m is the pixel display region PA for displaying an image. The light shielding layer 21b of the light shielding member 21 illustrated in FIG. 7 covers the cell region 22m and is formed in a region that spreads slightly outward from the cell region 22m, but may be formed in a region matching with the cell region 22m.

Referring back to FIG. 3, the polarizing plate 23 of the composite display member 20 is arranged on the face side of the image display device 22. The polarizing plate 23 is obtained by boning a polarizing film 23b of an absorbing type on a flat plate 23a having light transmittance. The polarizing film 23b is, for example, a resin sheet obtained by extending PVA with iodine adsorbed thereon in a specific direction. In the illustrated example, the polarizing film 23b only transmits vertically polarized light having a polarization plane parallel to the vertical ±Y direction, and absorbs horizontally polarized light having a polarization plane parallel to the horizontal ±X direction. In other words, the polarizing film 23b regulates transmitted light in a predetermined polarization direction, specifically, into vertically polarized light being light polarized in a first direction, and blocks horizontally polarized light being light polarized in a second direction orthogonal to the first direction. As a result, unless image light ML that is emitted from the pixel section 22t or the cell region 22m of the image display device 22 is originally polarized light, only the image light ML being vertically polarized light is transmitted through the polarizing plate 23. Of the external light OL that passes through the light transmitting region A1 of the light shielding member 21 and passes through the light transmitting region 22u or the light transmitting region A2 of the image display device 22, the horizontally polarized light is blocked by the polarizing plate 23, and the vertically polarized light passes through the polarizing plate 23.

The image selection conversion member 24 is arranged on the face side of the polarizing plate 23. The image selection conversion member 24 selectively changes the polarization direction of the image light ML according to the pixel display region PA (see FIG. 5). The image selection conversion member 24 is obtained by providing a rectangular wavelength plate 24b on a flat plate 24a having light transmittance. Although omitted in illustration, on the entire image selection conversion member 24, a large number of wavelength plates 24b are arrayed in a matrix along the XY plane. In other words, all the wavelength plates 24b constituting the image selection conversion member 24 are two-dimensionally arrayed periodically with respect to the horizontal X direction and the vertical Y direction. Each of the wavelength plates 24b is formed in a region corresponding to the cell region 22m or the light emitting region EA of each of the repetition units 20a. A light transmitting region A3 of the image selection conversion member 24 in which the wavelength plate 24b is not provided transmits the external light OL. The wavelength plate 24b changes the image light ML being vertically polarized light in the first direction, which is emitted from the cell region 22m of the image display device 22 and passes through the polarizing plate 23, into the image light ML being horizontally polarized light in the second direction orthogonal to the first direction. The wavelength plate 24b is a ½ wavelength plate for changing the polarization direction of the image light ML, and converts the image light ML being vertically polarized light having a polarization plane parallel to the Y direction into the image light ML being horizontally polarized light having a polarization plane parallel to the X direction by setting a delayed-phase axis or an optical axis to a 45-degree direction between the +X direction and the +Y direction, for example.

For example, as a method of creating the wavelength plate 24b, one possible approach involves uniformly applying a light alignment material containing a specific type of liquid crystal onto the flat plate 24a, adjusting alignment by irradiation with polarization UV light, and fixing the light alignment material by executing a fixation process with heating temperature and duration while maintaining the alignment. Further, a wavelength plate can also be obtained by forming a base layer by nano-imprinting or the like and then repeatedly forming deposition films on the base layer to form a crystal lattice structure.

In the description given above, it is assumed that the polarizing plate 23 only transmits the image light ML being vertically polarized light and the image selection conversion member 24 selectively changes or converts the image light ML being vertically polarized light into the image light ML being horizontally polarized light. However, the polarizing plate 23 may only transmit the image light ML being horizontally polarized light, for example. In this case, it is assumed that the image selection conversion member 24 includes a function of selectively changing or converting the image light ML being horizontally polarized light into the image light ML being vertically polarized light. With regard to the polarization separation liquid crystal lens 40, which is described later, it is required to change the polarization directions for the lens function accordingly as the functions of the polarizing plate 23 and the image selection conversion member 24 are changed.

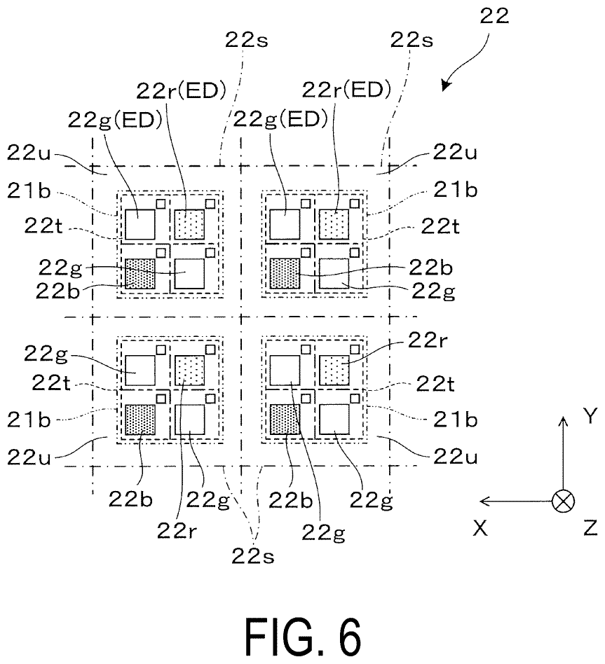

FIG. 8 is a view for describing a structure and a function of the polarization separation liquid crystal lens 40 or the liquid crystal lens 41 that is the polarization separation lens element 40a. In FIG. 8, an upper side al is a conceptual perspective view of the liquid crystal lens 41, and a lower side α2 is a chart illustrating a distribution state of retardation of the liquid crystal lens 41. The liquid crystal lens 41 is a lens that functions as a lens with respect to a specific polarization component, and is capable of changing the lens function, that is, power by external control. In other words, the liquid crystal lens 41 has refractive power that selectively acts on polarization of the image light ML, and is capable of changing the refractive power for each of the orbicular zones RA. When vertically polarized light and horizontally polarized light are incident, the liquid crystal lens 41 selectively acts as a lens on polarized light in one direction according to distribution of a refractive index, and transmits polarized light in the other direction substantially as it is without acting thereon. Here, specifically, the polarized light in one direction corresponds to the image light ML being horizontally polarized light, and the polarized light in the other direction corresponds to the external light OL. When distribution of a refractive index on the liquid crystal lens 41 is increased or reduced overall, the refractive power of the liquid crystal lens 41 can also be increased or reduced.

The liquid crystal lens 41 as the polarization separation lens element 40a includes a lens member 41a and a drive circuit 41c. The lens member 41a includes two light transmitting substrates 43a and 43b facing each other, two electrode layers 44a and 44b provided on the inner surfaces of the light transmitting substrates 43a and 43b, and a liquid crystal layer 45 interposed between the electrode layers 44a and 44b. Not that, although not illustrated in the drawing, alignment films are arranged between the electrode layers 44a and 44b and the liquid crystal layer 45 to adjust an initial alignment state of the liquid crystal layer 45. The first electrode layer 44a includes a large number of electrodes 47 arranged concentrically along the XY plane in the orbicular zone RA, and the electrodes 47 are annular transparent electrodes. The large number of electrodes 47 are spaced apart from each other, and the lateral width of the electrode 47 located on the outer side is narrowed. The lateral width of the electrode 47 affects the accuracy of a refraction action of the lens member 41a. The electrodes 47 are coupled to the drive circuit 41c via a wiring 48 insulated by an insulating layer, which is not illustrated in the drawing, on a route in the middle. The second electrode layer 44b is a common electrode extending parallel to the XY plane, and is uniformly formed along the light transmitting substrate 43b. Different application voltages V1 to V7 are applied to the large number of electrodes 47 to change a distribution state of birefringence or retardation. When the liquid crystal lens 41 has an effect of a convex lens, the application voltage V1 is set higher than the application voltage V7, and the application voltages V2 to V6 are set to values gradually changed within a voltage range of V1 to V7.

Description is made on a case in which the image light ML emitted from the image display device 22 is incident on the liquid crystal lens 41 via the image selection conversion member 24 and the like, in other words, a case in which the horizontally polarized light having a polarization plane parallel to the X direction is incident on the liquid crystal lens 41. With regard to the horizontally polarized light, a voltage applied to the electrode 47 that is arranged at the outermost side in the peripheral portion is increased to reduce retardation, and the refractive index is relatively reduced in the region. Thus, for example, in a case of light from a far point light source, the light that passes through the liquid crystal lens 41 via the electrode 47 in the peripheral portion has a wavefront that relatively advances. In contrast, a voltage applied to the electrode 47 that is arranged at the innermost side being the center portion is reduced to maintain retardation close to its original state, and the refractive index is relatively increased in the region. Thus, for example, in a case of light from a far point light source, the light that passes through the liquid crystal lens 41 via the electrode 47 in the center portion has a wavefront that is relatively delayed. Thus, image light MLO in a diverging state which is incident on the liquid crystal lens 41 from an image RI set on a predetermined focal plane FP is horizontally polarized light, and passes through the liquid crystal lens 41 to be subjected to an action as a convex lens and become image light MLPR in a state in which a diverging angle is reduced. Virtual image light MLPI that traces back the image light MLPR is from a virtual image position farther than the focal plane FP. A focal length of the liquid crystal lens 41 is a distance from a point light source to the liquid crystal lens 41 when light from the point light source is collimated. Approximately, with reference to the lens formula, the relationship expressed by 1/F=1/A+1/B is satisfied, where a distance from the focal plane FP to the liquid crystal lens 41 is A, a distance from the liquid crystal lens 41 to an image plane is B, and a focal length of the liquid crystal lens 41 is F. Here, the distance B from the focal plane FP to the virtual image position is set to a distance as several times to several tens of times as long as the distance A from the liquid crystal lens 41 to the focal plane FP. Although detail description is omitted, the distance ratio corresponds to a magnification ratio of a virtual image. In the above, when a relative ratio of the application voltages V1 to V7 is substantially maintained so that the application voltages are set to be low, a difference in retardation between the center and the periphery decreases, and an absolute value of positive power of the liquid crystal lens 41 decreases. That is, the absolute value of the power can be increased by applying a high voltage VH to the liquid crystal lens 41, the absolute value of the power can be decreased by applying a low voltage VL to the liquid crystal lens 41, and the drive circuit 41c allows the liquid crystal lens 41 to function as an externally adjustable varifocal lens.

The liquid crystal lens 41 functions as a varifocal lens to change the focal length F. Thus, the distance B from the liquid crystal lens 41 to the image plane position or the virtual image position can freely be changed, and adjustment of a magnification ratio can be performed. Further, even when visual acuity of the wearer US is imbalanced due to nearsightedness or the like, focus adjustment for observing a virtual image while maintaining a focused state can be performed. In other words, the image plane position or the virtual image position can be adjusted finely according to visual acuity of an individual (farsightedness, nearsightedness, astigmatism, or the like). The wearer US can perform adjustment of a magnification ratio or focus adjustment by operating the user terminal 88, for example. In other words, the virtual image display devices 100A and 100B enable customization relating to a magnification ratio and focus by an operation by the wearer US.

The liquid crystal lens 41 has an image formation action with respect to the image light ML being horizontally polarized light or vertically polarized light. The liquid crystal lens 41 may be regarded as a liquid crystal lens including a function as a lens with respect to a specific polarization component, and may also be regarded as a liquid crystal lens having a lens function acting on a specific polarization component. When the liquid crystal lens 41 is arranged in front of the eyes, an eye box having a size close to that of the liquid crystal lens 41 can be secured. The eye box can be increased in size, and chipping of an image is less likely to occur. Moreover, the display optical systems 103a and 103b that are reduced in size and have a large FOV can be achieved at the same time. Moreover, the composite display member 20 including the image display device 22, the polarizing plate 23, the image selection conversion member 24, and the like and the liquid crystal lens 41 are combined with each other, and thus display on a large screen can be performed with a small-sized optical system. Here, display on a large screen indicates a case in which a virtual image of 70 inches or larger is formed at a distance of 2.5 m ahead, for example.

The liquid crystal lens 41 is not required to be used with variable focus, and may be used with fixed focus. The liquid crystal lens 41 is not limited to one in which retardation is gradually reduced from the center to the periphery, but may also be a Fresnel lens as disclosed, for example, in International Publication WO2009/072670. The liquid crystal lens 41 may change the alignment direction of the liquid crystal by ultrasonic waves.

The external light OL that passes through the light shielding member 21 and the like is vertically polarized light, and even when the external light OL passes through the liquid crystal lens 41, retardation is maintained uniform in the XY plane regardless of the values of the application voltages V1 to V7. Thus, a phase difference is not imparted, and the external light OL is not affected by a lens action of the liquid crystal lens 41. In other words, the external light OL linearly advances without being substantially affected by the composite display member 20 and the polarization separation liquid crystal lens 40.

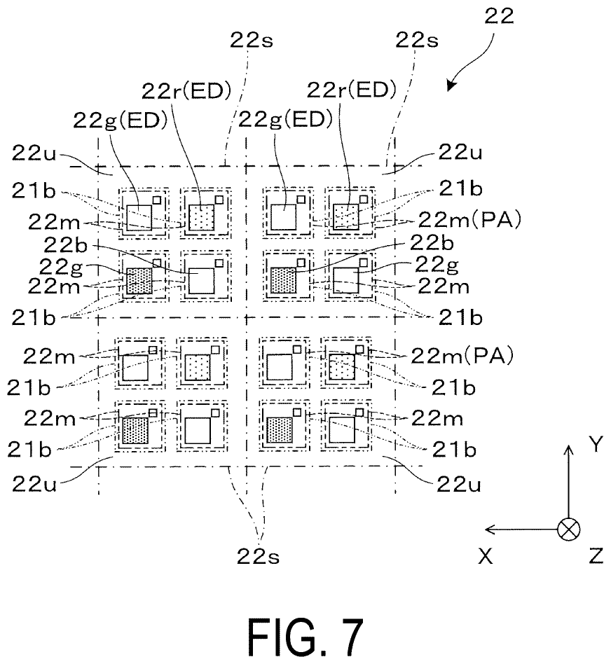

With reference to FIG. 9, the image light ML that is emitted from the light emitting element ED or the light emitting layer 22e of the image display device 22 is turned into only vertically polarized light P1 via the polarizing plate 23, is selectively changed from the vertical polarization direction to the horizontal polarization direction via the image selection conversion member 24, and is emitted as horizontally polarized light P2. The image light ML that passes through the image selection conversion member 24 forms a virtual image via the liquid crystal lens 41 of the polarization separation liquid crystal lens 40 functioning as a convex lens with respect to the horizontally polarized light. An image that is formed on the image display device 22 being a transparent display is observed by the eyes EY of the wearer as a virtual at a desired magnification ratio behind the image display device 22. Meanwhile, the external light OL passes through the light transmitting region A1 of the light shielding member 21, passes through the light transmitting region 22u having a parallel flat plate-like shape or the light transmitting region A2 of the image display device 22, passes through the polarizing plate 23 to vertically regulate the polarization direction, and passes through the light transmitting region A3 of the image selection conversion member 24, which has a parallel flat plate-like shape. In this state, the external light OL is not subjected to a lens action due to the light shielding member 21, the image display device 22, the polarizing plate 23, and the image selection conversion member 24. A general external image is observed by the eyes EY of the wearer. In other words, an external image can be recognized in a see-through view via the display optical systems 103a and 103b.

With reference to FIG. 5A and the like, the repetition section 22s may be regarded as a combination of an external light visual recognition pixel X1 being the light transmitting region 22u and an image light emission pixel X2 being the pixel section 22t or the pixel display region PA, and is also referred to as a see-through image display pixel TX. The see-through image display pixel TX locally blocks the external light OL, and forms a pixel at a shielded position. In view of this, the see-through image display pixel TX may be regarded as a pixel that allows a background scene to be viewed in a see-through manner. The external light OL that is not blocked by the light shielding member 21 passes through the light transmitting region 22u being a part of the see-through image display pixel TX of the image display device 22 while the polarizing plate 23 regulates the polarization direction, passes through the image selection conversion member 24 as it is, and also passes through the liquid crystal lens 41 while maintaining a light beam state. Meanwhile, the polarization direction of the image light ML that is emitted from the pixel display region PA being a part of the see-through image display pixel TX is regulated by the polarizing plate 23, and is switched to an orthogonal polarization direction by the image selection conversion member 24. The image light ML passes through the liquid crystal lens 41 while being subjected to a light condensing action or a lens action, and is converted into a virtual image of the pixel display region PA.

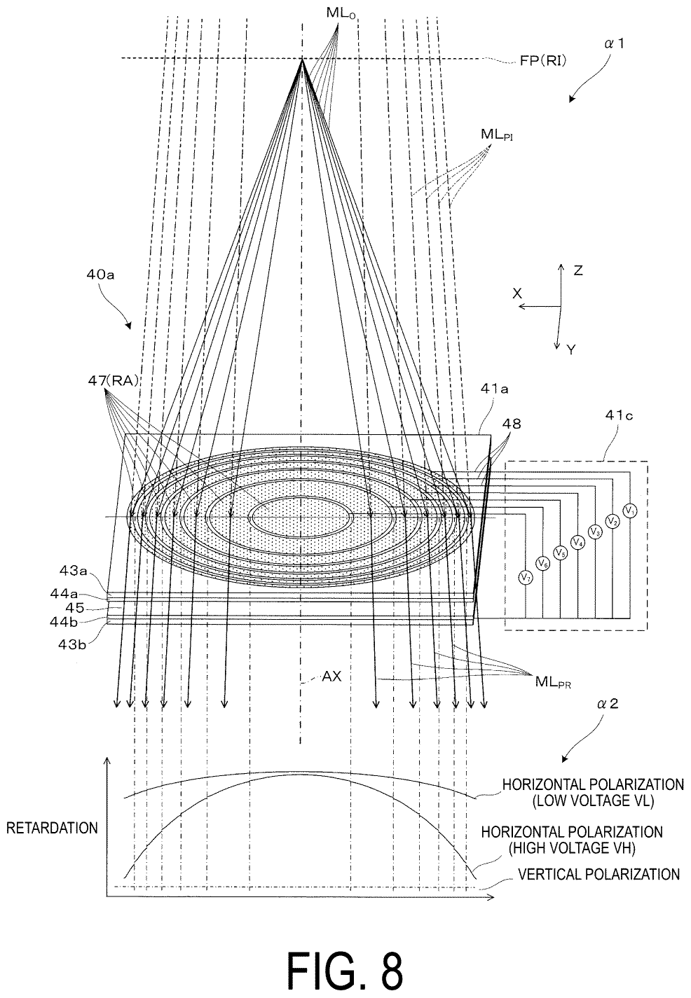

FIG. 10 illustrates a modification example of the display optical systems 103a and 103b illustrated in FIGS. 3, 9, and the like. In this case, on the image selection conversion member 24, the wavelength plate 24b is formed in a region unit corresponding to the pixel section 22t, instead of a region unit corresponding to the cell region 22m. In this case, the external light OL also passes through the light transmitting region A3 of the image selection conversion member 24 in which the wavelength plate 24b is not present, and is not subjected to a lens action.

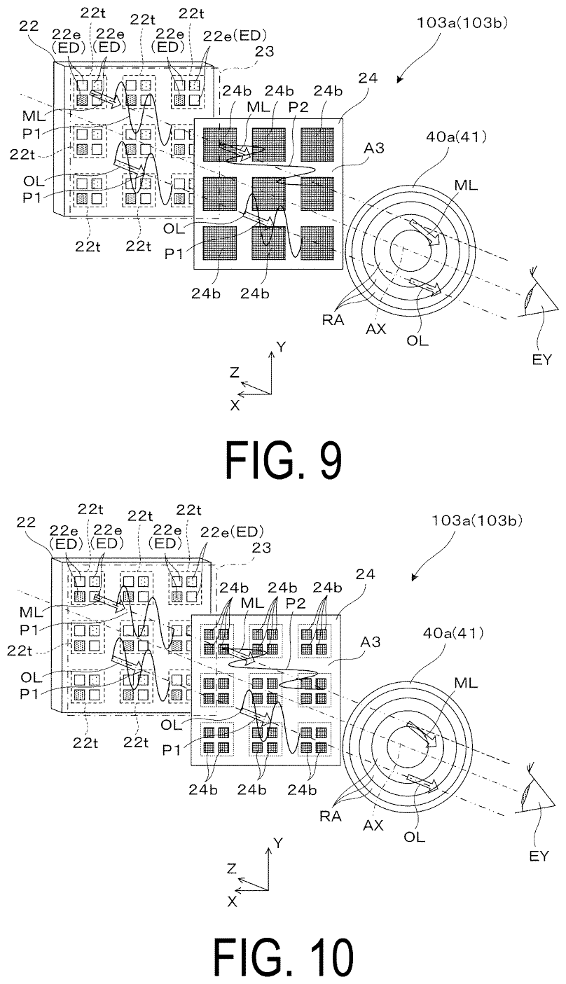

FIG. 11 is a plan view illustrating a modification example relating to the image selection conversion member 24 and the like. In this case, the wavelength plate 24b is directly formed on a polarizing plate 323, and the polarizing plate 323 and the image selection conversion member 24 are integrated with each other. In other words, the polarizing plate 323 illustrated herein includes a function obtained by combining the function of the polarizing plate 23 and the function of the wavelength plate 24b that are illustrated in FIG. 3.

The virtual image display devices 100A and 100B of the first exemplary embodiment described above includes the image display device 22 including the pixel display region PA for displaying an image and the light transmitting region 22u for causing externals to be visually recognizable, the light shielding member 21 being arranged on the external side of the image display device 22 and being configured to suppress incidence of the external light OL on the pixel display region PA, the polarizing plate 23 being arranged on the face side of the image display device 22 and being configured to limit transmitted light to the predetermined polarization direction, the image selection conversion member 24 being arranged on the face side of the polarizing plate 23 and including the wavelength plate 24b for selectively changing the polarization direction of the image light ML according to the pixel display region PA, and the polarization separation liquid crystal lens 40 as the polarization separation lens element 40a being arranged on the face side of the image selection conversion member 24 and having refractive power selectively acting on polarization of the image light ML.

In the virtual image display devices 100A and 100B described above, the transmitted light that passes through the light shielding member 21 from the external side is regulated in the predetermined polarization direction via the polarizing plate 23, and passes through the polarization separation lens element 40a, that is, the polarization separation liquid crystal lens 40 without being subjected to an action of refractive power. The image light ML that is emitted from the pixel display region PA of the image display device 22 is regulated in the predetermined polarization direction via the polarizing plate 23, the deflection direction of the image light ML is converted by the wavelength plate 24b of the image selection conversion member 24, and the image light ML passes through the polarization separation lens element 40a, that is, the polarization separation liquid crystal lens 40 while being subjected to an action of refractive power. In this manner, a virtual image is formed. In this case, a virtual image can be formed while the image display device 22 and the polarization separation lens element 40a are arranged near the eye EY, and an angle of view can be increased without significantly separating the image display device 22 and the polarization separation liquid crystal lens 40 from each other. In particular, the polarization separation lens element 40a is an independent lens, and hence an eye box can be enlarged.

### Second Exemplary Embodiment

A virtual image display device according to a second exemplary embodiment is described below. The virtual image display device according to the second exemplary embodiment is obtained by partially modifying the virtual image display device according to the first exemplary embodiment, and description of parts in common with those of the virtual image display device according to the first exemplary embodiment is omitted.

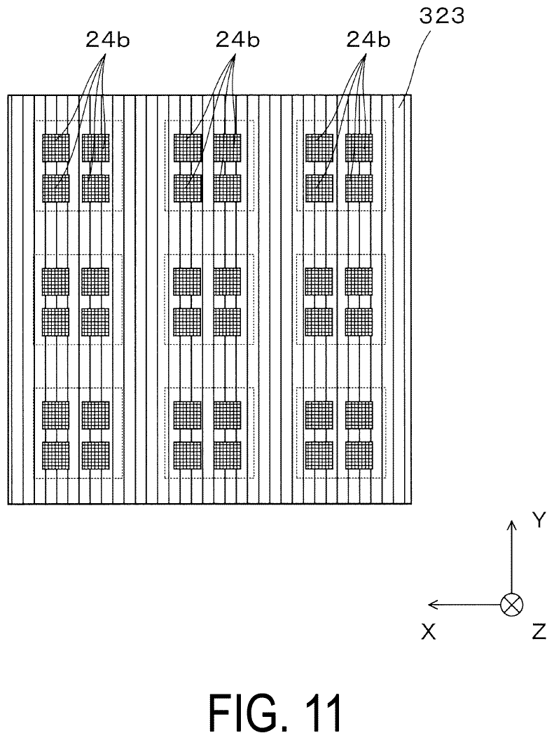

With reference to FIG. 12, in the virtual image display devices 100A and 100B or the HMD 200 of the second exemplary embodiment, a polarization separation lens element 240a configured by a liquid crystal lens array 241 is arranged in the vicinity of the face side of the composite display member 20. The polarization separation lens element 240a includes a plurality of lens elements 49e that cause the pixels PE or the sub pixels PEa constituting the image display device 22 to form an image individually. Each of the lens elements 49e has a structure similar to that of the liquid crystal lens 41 or the polarization separation liquid crystal lens 40 illustrated in FIG. 8.

### Modification Examples and Others

Although the present disclosure has been described with reference to the above-described exemplary embodiments, the present disclosure is not limited to the above-described exemplary embodiments and can be implemented in various modes without departing from the spirit of the disclosure. For example, the following modifications are possible.

In the exemplary embodiment described above, the liquid crystal lens 41 is not limited to one including the electrode as an element, and may be one having refractive power by filling a space between a Fresnel lens-like first base plate and a flat plate-like second base plate with liquid crystal and aligning the alignment of the liquid crystal with a Fresnel lens surface.

The liquid crystal lens 41 may include an elongated circular electrode that is slightly elongated in a specific direction, instead of a circular electrode.

The liquid crystal lens 41 as the polarization separation lens element 40a is not limited to a lens including the orbicular zone RA having a circular shape. As the polarization separation lens element 40a, various structures having a lens action with respect to specific polarized light may be adopted.

The polarizing plate 23 may be one that transmits the horizontally polarized light, for example. In this case, for example, on the image selection conversion member 24, a wavelength plate is formed in a region facing the light transmitting region 22u of the image display device 22 through which the external light OL passes, and the image light ML is simply transmitted in a region facing the pixel section 22t or the pixel display region PA. Similarly, in this case, the image light ML being horizontally polarized light is subjected to a lens action by the liquid crystal lens 41, and the external light OL being vertically polarized light is not subjected to a lens action by the liquid crystal lens 41. The polarizing plate 23 may transmit obliquely polarized light in an intermediate direction between the X direction and the Y direction, for example. In this case, for example, the wavelength plate formed on the image selection conversion member 24 is in a state in which the posture is rotated about the optical axis AX and the delayed-phase axis is tilted. Further, the posture of the liquid crystal lens 41 is similarly rotated about the optical axis AX so that the direction in which the refractive power is generated and the polarization direction of the image light ML match with each other.

The light shielding layer 21b of the light shielding member 21 may be formed in a region unit corresponding to the cell region 22m, instead of a region unit corresponding to the pixel section 22t.

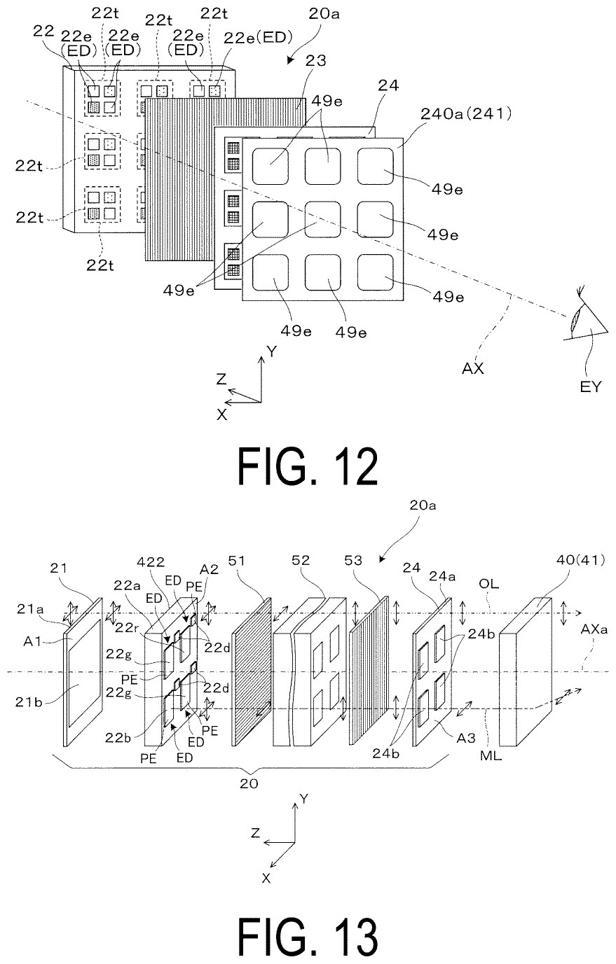

As illustrated in FIG. 13, in the composite display member 20, the image display device 22 is replaced with a backlight 422 including light emission arrays similar to the pixel arrays, and the polarizing plate 23 is removed. Then, a liquid crystal panel 52 of, for example, a TN type including transparent electrodes corresponding to the light emission arrays of the backlight 422, a polarizing plate 51 for horizontal polarization, and a polarizing plate 53 for vertical polarization are arranged in an optical path. In this case, a display element of a light modulation type is used in place of the display element of a self light emission type. The composite display member 20 is operated in a normally on mode or a normally white mode. The illumination light from the backlight 422 is adjusted by the liquid crystal panel 52 and the like, is emitted as the image light ML being vertically polarized light, is changed to horizontally polarized light by the image selection conversion member 24, and is subjected to a lens action by the liquid crystal lens 41. Note that, when a large voltage is applied to a pixel electrode of the liquid crystal panel 52, only the image light ML being horizontally polarized light is present, and the image light ML is blocked by the polarizing plate 53 and is not incident on the liquid crystal lens 41. Regardless of a voltage to be applied to a pixel electrode of the liquid crystal panel 52, the external light OL passes through the polarizing plate 53 without any loss, and is incident on the liquid crystal lens 41 as vertically polarized light. Thus, the external light OL is not subjected to a lens action.

Although it has been assumed above that the HMD 200 is worn on the head and is used, the virtual image display devices 100A and 100B may also be used as a hand-held display that is not worn on the head and is to be looked into like binoculars. In other words, the head-mounted display also includes a hand-held display in the present disclosure.

According to a specific aspect, a virtual image display device includes an image display device including a pixel display region for displaying an image and a light transmitting region for causing externals to be visually recognizable, a light shielding member being arranged on an external side of the image display device and being configured to suppress incidence of external light on the pixel display region, a polarizing plate being arranged on a face side of the image display device and being configured to limit transmitted light to a predetermined polarization direction, an image selection conversion member being arranged on a face side of the polarizing plate and including a wavelength plate for selectively changing a polarization direction of image light according to the pixel display region, and a polarization separation lens element being arranged on a face side of the image selection conversion member and having refractive power selectively acting on polarization of the image light.

In the virtual image display device described above, the transmitted light that passes through the light shielding member from the external side is regulated in the predetermined polarization direction via the polarizing plate, and passes through the polarization separation lens element without being subjected to an action of refractive power. The image light that is emitted from the pixel display region of the image display device is regulated in the predetermined polarization direction via the polarizing plate, the deflection direction of the image light is converted by the wavelength plate of the image selection conversion member, and the image light passes through the polarization separation lens element while being subjected to an action of refractive power. In this manner, a virtual image is formed. In this case, a virtual image can be formed while the image display device and the polarization separation lens element are arranged near the eye, and an angle of view can be increased without significantly separating the image display device and the polarization separation lens element from each other.

In the virtual image display device according to the specific aspect, the pixel display region is a light emitting region corresponding to a pixel or a sub pixel, and the wavelength plate is arranged in a region corresponding to the light emitting region. With this, blockage of the external light passing through the light emitting region can be suppressed while the image light that is emitted from the light emitting region to the face side is used for formation of a virtual image.

In the virtual image display device according to the specific aspect, the light shielding member is arranged in a region corresponding to a pixel or a sub pixel of the pixel display region. The light shielding member can prevent the external light incident at the position to enter the path of the image light and become stray light.

In the virtual image display device according to the specific aspect, the polarizing plate limits the image light from the image display device and external light passing through the light shielding member to polarized light in a first direction, and transmits the light, and the image selection conversion member converts the image light passing through the polarizing plate into polarized light in a second direction orthogonal to the first direction. As a result, interference between the image light and the external light can be suppressed.

In the virtual image display device according to the specific aspect, the polarization separation lens element is a polarization separation liquid crystal lens that collectively causes a plurality of pixels constituting the image display device to form an image. With an independent lens, an eye box can be enlarged.

In the virtual image display device according to the specific aspect, the polarization separation lens element is a polarization separation liquid crystal lens including a plurality of element lenses that causes respective pixels or sub pixels constituting the image display device to form an image individually. The plurality of element lenses are arranged in the vicinity of the image display device, and hence the virtual image display device can be reduced in thickness.

In the virtual image display device according to the specific aspect, the polarization separation liquid crystal lens includes a plurality of orbicular zones each having a circular shape and being arranged concentrically.

In the virtual image display device according to the specific aspect, in the polarization separation liquid crystal lens, refractive power of the orbicular zones is changed according to an application voltage. The liquid crystal lens enables adjustment of a projection distance or adjustment of a diopter, and focal point adjustment can swiftly be performed with respect to a polarization component of the image light.

According to a specific aspect, a head-mounted display apparatus includes a first device including the virtual image display device described above, a second device including the virtual image display device described above, and a support device including a temple configured to support the first device and the second device so that the first device and the second are wearable on a head.

What is claimed is:

1. A virtual image display device, comprising:
an image display device including a pixel display region for displaying an image and a light transmitting region for causing externals to be visually recognizable;
a light shielding member being arranged on an external side of the image display device and being configured to suppress incidence of external light on the pixel display region;
a polarizing plate being arranged on a face side of the image display device and being configured to limit transmitted light to a predetermined polarization direction;
an image selection conversion member being arranged on a face side of the polarizing plate and including a wavelength plate for selectively changing a polarization direction of image light according to the pixel display region; and
a polarization separation lens element being arranged on a face side of the image selection conversion member and having refractive power selectively acting on polarization of the image light.

2. The virtual image display device according to claim 1, wherein
the pixel display region is a light emitting region corresponding to a pixel or a sub pixel, and
the wavelength plate is arranged in a region corresponding to the light emitting region.

3. The virtual image display device according to claim 1, wherein
the light shielding member is arranged in a region corresponding to a pixel or a sub pixel of the pixel display region.

4. The virtual image display device according to claim 1, wherein
the polarizing plate limits the image light from the image display device and external light passing through the light shielding member to polarized light in a first direction, and transmits the light, and
the image selection conversion member converts the image light passing through the polarizing plate into polarized light in a second direction orthogonal to the first direction.

5. The virtual image display device according to claim 1, wherein
the polarization separation lens element is a polarization separation liquid crystal lens that cause a plurality of pixels constituting the image display device to collectively form an image.

6. The virtual image display device according to claim 1, wherein
the polarization separation lens element is a polarization separation liquid crystal lens including a plurality of element lenses that cause respective pixels or sub pixels constituting the image display device to form an image individually.

7. The virtual image display device according to claim 5, wherein
the polarization separation liquid crystal lens includes a plurality of orbicular zones having a circular shape and being arranged concentrically.

8. The virtual image display device according to claim 7, wherein
in the polarization separation liquid crystal lens, refractive power of the orbicular zones changes according to an application voltage.

9. A head-mounted display apparatus, comprising:
a first device including the virtual image display device according to claim 1;
a second device including the virtual image display device according to claim 1; and
a support device including a temple configured to support the first device and the second device so that the first device and the second are wearable on a head.
